(19) United States
(12) Patent Application Publication
(10) Pub. No.: US 2016/0057588 A1
(43) Pub. Date: Feb. 25, 2016

(54) REPLY TO SHORT MESSAGE

(71) Applicants: ROBERT REISIG, Eldersburg, MD (US); Dara Ung, Harwood, MD (US); Phillip Geil, Clarksville, MD (US); William Burke, Arnold, MD (US)

(72) Inventors: ROBERT REISIG, Eldersburg, MD (US); Dara Ung, Harwood, MD (US); Phillip Geil, Clarksville, MD (US); William Burke, Arnold, MD (US)

(73) Assignee: TELECOMMUNICATION SYSTEMS, INC., Annapolis, MD (US)

(21) Appl. No.: 14/536,113

(22) Filed: Nov. 7, 2014

Related U.S. Application Data
(60) Provisional application No. 62/041,493, filed on Aug. 25, 2014.

(51) Int. Cl. H04W 4/14; H04M 1/725

(52) U.S. Cl. CPC H04W 4/14; H04M 1/72552

(57) ABSTRACT

An end-user device can include a graphical user interface (GUI). The GUI can be configured to control the display to visually associate a reply short message with a given short message identified in the reply short message.

### CROSS-REFERENCE TO RELATED APPLICATION

This application claims the benefit of priority to U.S. Provisional Application No. 62/041,493 filed on Aug. 25, 2014, and entitled TRUREPLY—REPLY TO SPECIFIC MESSAGES INSTEAD OF THE ORIGINATOR, the entirety of which is herein incorporated by reference.

### TECHNICAL FIELD

This disclosure relates to generating a reply to a short message.

### BACKGROUND

Text messaging, or texting, is the act of composing and sending brief, electronic messages (e.g., a short message) between two or more mobile or fixed devices over a phone network. The term originally referred to messages sent using the Short Message Service (SMS), but the term has grown to include messages containing image, video, and sound content (known as Multimedia Messaging Service (MMS) messages). The sender of a text message can be referred to as a “texter”, while the service itself has different colloquialisms depending on the region.

### SUMMARY

One example relates an end-user device that can include a display configured to output short messages. The end-user device can include a memory configured to store machine readable instructions and data. The end-user device can also include a processing unit configured to access the memory and execute the machine readable instructions. The machine readable instructions can include a graphical user interface (GUI) configured to control the display to visually associate a reply short message with a given short message identified in the reply short message.

Another example relates to a non-transitory machine readable medium having machine executable instructions. The machine executable instructions can include a GUI configured to output a given short message sent from a sender, wherein the given short message includes a message identifier 224. The GUI can also be configured to output another short message sent from the sender. The GUI can further be configured to generate a reply short message to the given short message. The reply short message can include the message ID for the given short message. The GUI can further be configured to arrange the display such that the reply short message is visually associated with the given short message.

Yet another example is related to an end-user device that can include a display configured to output short messages. The end-user device can also include a memory configured to store machine readable instructions and data. The end-user device can further include a processing unit configured to access the memory and execute the machine readable instructions. The machine readable instructions can include a GUI configured to output a first short message sent from a sender. The first short message can include a message ID. The GUI can be configured to output a second short message sent from the sender. The GUI can also be configured to generate a reply short message to the first short message. The reply short message can include the message ID for the first short message. The GUI can further be configured to arrange the display such that the reply short message is visually associated with the first short message and output a third short message from the sender. The third short message can be a reply to the reply short message, and the third short message can be positioned below the reply short message and above the second short message.

Still another example relates to a method that can include receiving an incoming short message. The method can also include determining that the incoming short message is a reply short message to a given short message. The method can further include arranging an output of short messages such that the reply short message is displayed below the given short message and above another short message. The other short message can be generated prior to the receiving of the given short message.

Yet still another example relates to a method that can include receiving a given short message and another short message from a sender. The method can also include generating a reply short message to the given short message, after the receiving. The method can further include sending the reply short message to the sender via a telecommunications carrier network and arranging a display of short messages such that the reply short message is visually associated with the given short message.

### BRIEF DESCRIPTION OF THE DRAWINGS

FIG. 1 illustrates an example of a system for sending and receiving short messages.

FIGS. 2-6 illustrate example screenshots of for end-user devices outputting short messages.

FIG. 7 illustrates an example of an end-user device for sending and receiving short messages.

FIG. 9 illustrates an example of a flowchart of an example method for generating a reply short message.

FIG. 8 illustrates an example of a flowchart of an example method for receiving a reply short message.

### DETAILED DESCRIPTION

Examples for replying to a specific short message (e.g., a text message and/or multimedia message) transmitted over a telecommunications carrier network are described. In particular, a user of an end-user device can select a given short message of multiple short messages and reply to the given short message, and forward a generated reply short message to a sender (another end-user device) of the given short message. The sender of the given short message (the other end-user device) can be configured to arrange a displaying of short messages such that the reply short message is visually associated with the given short message. Such visual association can include, for example, positioning the reply short message beneath the given short message and above other short messages, even if some (or all) of the other short messages are generated and/or received prior to receipt of the reply short message. In this manner, users of end-user devices can quickly determine that the reply short message is intended to be a specific reply to the given short message and not a reply to other short messages. By employing the systems and methods described herein, two users (a user of the given device and a user of the other device) can more effectively communicate via short messages. In particular, each user can reply to specific short messages, thereby making such replies more intelligible.

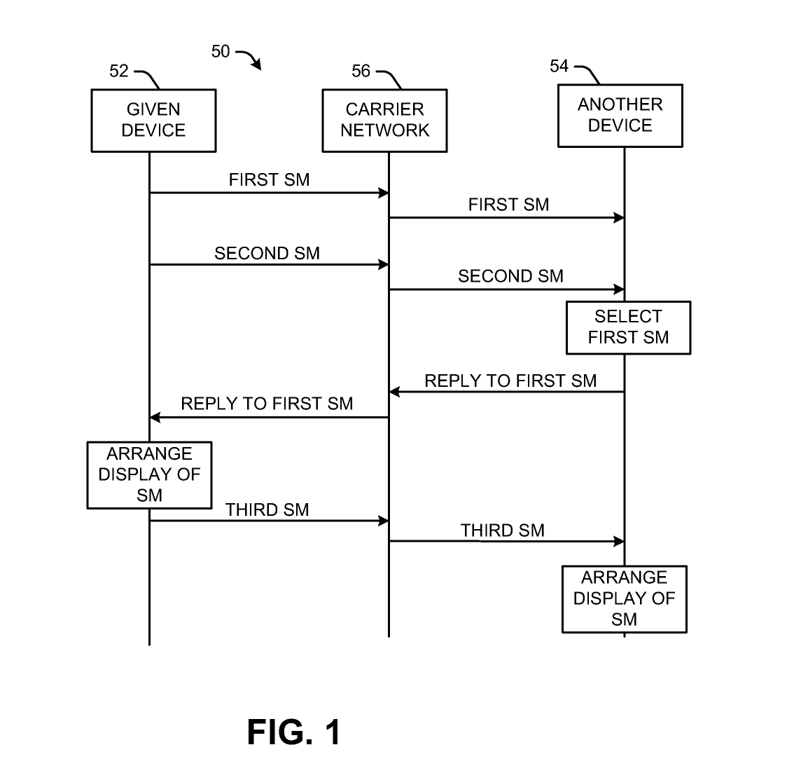

FIG. 1 illustrates an example of a system 50 for sending and receiving short messages (also known as text messages). As used herein, the term “short message” refers to a relatively brief electronic message that is sent from a mobile communications network subscriber via a telephone carrier network 56 (e.g., a telecommunications carrier network, a public network such as the Internet or a combination thereof). A short message can be sent, for example, using the short message service (SMS) protocol or the multimedia message service (MMS) protocol or other short message protocol, such as short message sent using the Internet Protocol (IP), which can be referred to as IP messages. Such IP messages could be implemented, as Over-the-top content (OTT) messages that are delivered via the Internet. Examples of such OTT messages could be a dedicated chat application (e.g., Apple iMessage®, WhatsApp®, etc.) a face-to-face video chat application (e.g., Skype®), Instant Messaging, etc. The short message can include text, an image, video and/or sound content.

The system 50 can include a given device 52 that can communicate with another device 54. Each of the given device 52 and the other device 54 can be implemented, for example, as end-user devices, such as a mobile telephone (e.g., a smart phone or a feature phone), a tablet computer, a laptop computer, a desktop computer, etc. The given device 52 and the other device 54 can communicate via a carrier network 56 (e.g., a phone carrier network). The carrier network 56 can be implemented, for example, as a telecommunications carrier network 56. Moreover, in some examples, the carrier network 56 can be representative of multiple carrier networks and/or the Internet, such as situations where the given device 52 and the other device 54 are subscribers to different carrier networks and/or in situations where the short messages are IP messages.

The given device 52 and the other device 54 can communicate via short messages. A series of short messages passed between the given device 52 and the other device 54 can be referred to as a conversation. Each short message transferred between the given device 52 and the other device 54 can include a unique identifier (ID). The unique ID for each short message can be included, for example, in a user data header (UDH) of the short message. Additionally, in some examples, the short message can include an identifier for a destination device (e.g., a phone number or name) and a time stamp.

As used herein, each message ID can be employed to uniquely identify a specific message sent and received between the sender and receiver. The message ID is first generated by the sending device for each newly composing message. The message ID, hidden from texters, is conveyed to the receiver along with the message content over a telecommunication media. The same message ID can be employed by the receiving device to reply back to the message originally composed by the sender in a manner described herein.

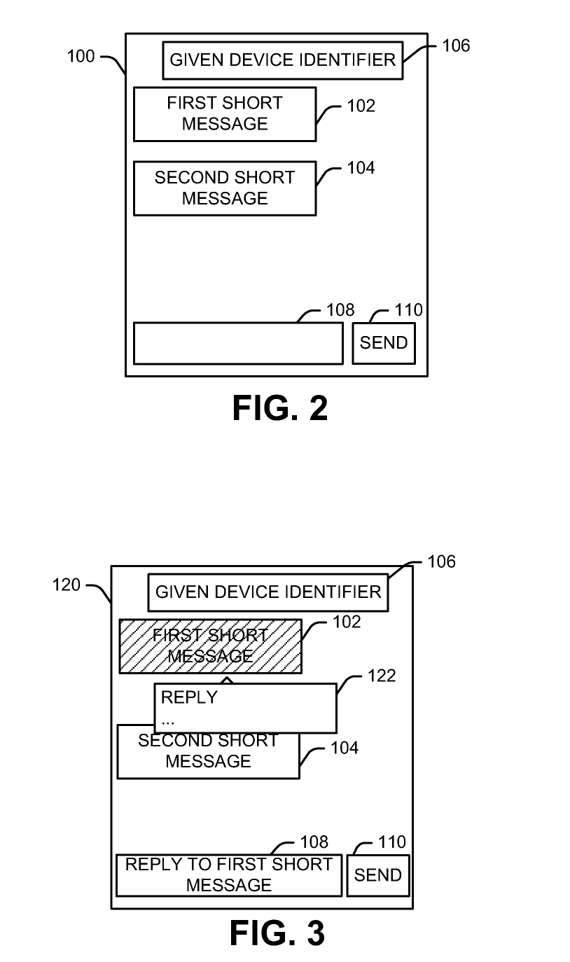

A first short message (labeled in FIG. 1 as “FIRST SM”) can be sent from the given device 52 to the carrier network 56. The carrier network 56 can forward the first short message to the other device 54. In some examples, the first short message can include a text with a question. The first short message can be output on a display of the other device 54. Additionally, the given device 52 can send the other device 54 a second short message (labeled in FIG. 1 as “SECOND SM”). The second short message can be sent to the other device 54 via the carrier network 56. The second short message can be output by the other device 54 on the display. In some examples, the second short message can include a question or statement unrelated to the first short message. FIG. 2 illustrates an example of a screenshot 100 of the display at the other device 54 after the content of the first short message 102 and the second short message 104 are received and are displayed. It is noted that for purposes of simplification of explanation, FIGS. 2-6 employ the same reference numbers to denote the same structure. In FIG. 2, the given device 52 can be identified with an identifier 106 (e.g., text). Additionally, content (e.g., text or other content) of the first short message and content of the second short message of FIG. 1 can be output in chronological order (e.g., the order in which the first and second short messages are received). Furthermore, the screenshot 100 includes a text box 108 for a user of the other device 54 to generate content for a short message for the given device 52 and a corresponding send button 110 (labeled in FIG. 2 as “SEND”) that can actuate a sending of a short message.

Referring back to FIG. 1, the other device 54 can select the first short message and prepare a reply to the first short message in response to user input. In such a situation, to select the first short message, the user can employ a graphical user interface (GUI) on the other device 54 to select the first short message. In some situations, the selection of the first short message can be made in response to a screen touch. In other situations, the selection of the first short message can be made in response to user input at a keypad. In examples where the selection of the first message is made in response to input at a keypad, each message displayed at the GUI of the other device can include a tag (e.g., #1, #2, etc.). In such a situation, the user can employ the keypad to enter the tag for the selected message.

The other device 54 can be programmed such that in response to the selection of the second short message, a menu, such as a drop down menu can be displayed, and the menu can provide an option for the user of the other device 54 to generate the reply to the first short message. That is, the menu can provide an option for the user to reply directly to the first short message. FIG. 3 illustrates an example of a screenshot 120 of the other device 54 after the first short message 102 has been selected for a reply. As illustrated in FIG. 3, upon selection of the first short message (e.g., via a touch or keypad selection), a dropdown menu 122 appears. Upon selection of a reply function (labeled in FIG. 3 as “REPLY”), the user of the other device 54 can generate a reply to the first short message in the text box. The user can select the send button to send the reply to the first short message.

In other examples, the user of the other device 54 can simply begin preparing content of a short message that is the reply to the first short message prior to receipt of the second short message. In such a situation, the other device 54 can be configured to automatically associate the short message with the first short message to form the reply to the first short message.

Referring back to FIG. 1, the reply to the first short message (labeled in FIG. 1 as “REPLY TO FIRST SM”) can be sent from the other device 54 to the carrier network 56. The reply to the first short message can include, for example, a unique ID for the reply to the first short message, as well as a unique ID for the first short message in the user data header. The carrier network 56 can forward the reply to the first short message to the given device 52. The given device 52 can review the reply to the first short message to associate the reply to the first short message with the first short message based on the first short message ID included in the user data header of the reply to the first short message. The given device 52 can arrange a display of the short messages at the given device 52, such that the reply to the first short message is visually associated with the first short message. In some situations, such a visual association can include displaying the reply short message beneath the first short message and above the second short message, such that there are no messages positioned between the first short message and the reply short message.

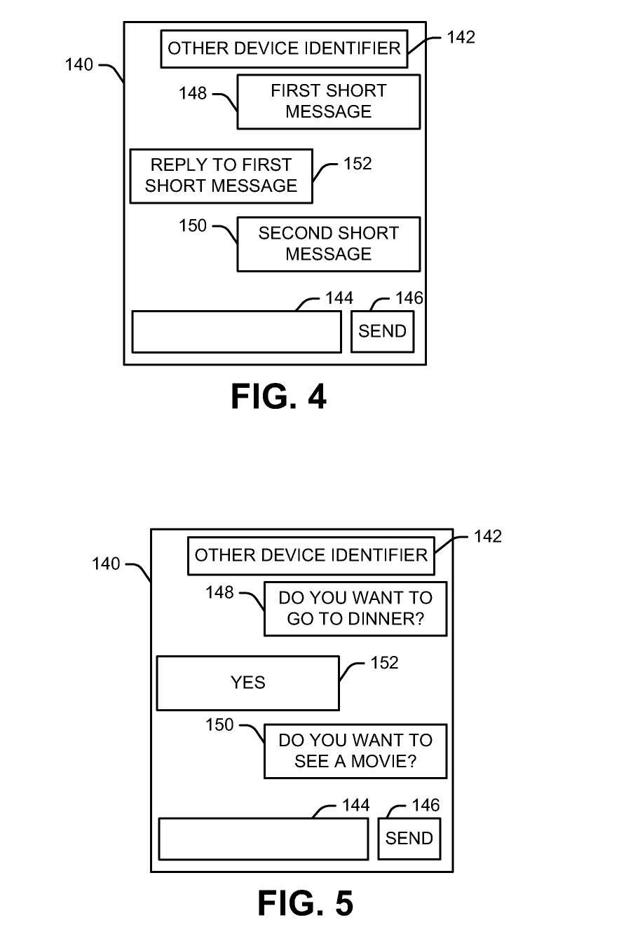

FIG. 4 illustrates an example of a screenshot 140 of a display at the given device 52 of FIG. 1, after the arrangement of the display. In FIG. 4, an identifier 142 (e.g., text) for the other device 54 can be output at the display of the short messages. Additionally, the screenshot 104 includes a text box 142 and a send button 146, similar to the text box 108 and send buttons 110 illustrated in FIGS. 2 and 3. Moreover, text (and/or other content) of the first short message 148 and the second short message 150 can be displayed. Additionally, content of the reply to the first short message 152 can be positioned beneath the first short message 148 and above the second short message 150 based on the arrangement of the display at the given device 52. In this manner, a user of the given device 52 can easily determine that the reply to the first short message 152 is in fact a reply to the first short message 148 and not a reply to the second short message 150. For instance, as noted the first short message 148 and the second short message 150 can be unrelated questions, such that a simple affirmative or negative answer may be ambiguous. This situation may be more readily understood with an example illustrated in FIG. 5.

FIG. 5 illustrates the screenshot in FIG. 4, wherein example text for the first short message 148, the second short message 150 and the reply to the first short message 152 is inserted. This first short message 148 includes a first question for the user of the other device 54, namely “DO YOU WANT TO GO TO DINNER?” The second short message 150 includes a second question for the user of the other device 54, namely “DO YOU WANT TO GO SEE A MOVIE?” By arranging the display of the given device 52, the reply to the first short message 152, namely “YES” is displayed in a manner that the user of the given device 52 immediately associates the reply of the first short message 152 with the first short message 148. In contrast, without such an arrangement, conventionally, the reply to the first short message 152 would be displayed below the second short message 150, such that the user of the given device 52 would be unable to determine whether the phrase “YES” is a response to the first short message or the second short message without additional information (e.g., another short message).

Referring back to FIG. 1, in a manner similar to the generation of the first short message, the user of the given device 52 can generate a third short message (labeled in FIG. 1 as, “THIRD SM”). In one example, the third short message can be a reply to the reply to the first short message that can be generated in a manner similar to the reply to the first short message. In some situations, the third short message could be referred to as a second reply short message. The third short message can include a unique ID for the third short message and the unique identifier of the reply to the first short message. The third short message can be provided to the carrier network 56, and the carrier network 56 can forward the third short message to the other device 54.

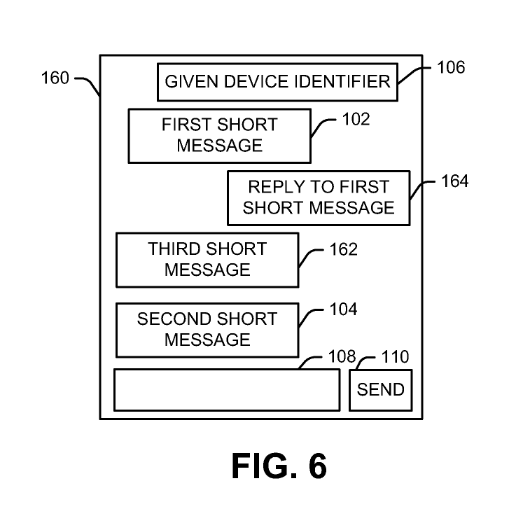

The other device 54 can extract the message ID for the reply to the first short message to associate the third short message with the reply to the first short message. Moreover, the other device 54 can (re)arrange the display of the short messages such that the third short message is displayed in a manner that visually associates the third short message with the reply to the first short message. FIG. 6 illustrates an example of a screenshot 160 of the other device 54 after such an arrangement of the display of short messages. FIG. 6 is similar to the screenshots 100 and 120 of FIGS. 2 and 3. As is illustrated in FIG. 6, the short messages are arranged such that content of the third short message 162 (a second reply) is displayed below the reply to the first short message 164, and above the second short message 104, even though (as noted) the second short message can be generated prior to the reply to the first short message 164 and the third short message 162. In this manner, the user of the other device 54 would immediately associate the third short message 162 with the reply to the first short message 164.

Referring back to FIG. 1, by employing the system 50, two users (a user of the given device 52 and a user of the other device 54) can more effectively communicate via short messages. In particular, each user can reply to specific short messages, thereby making such replies more intelligible.

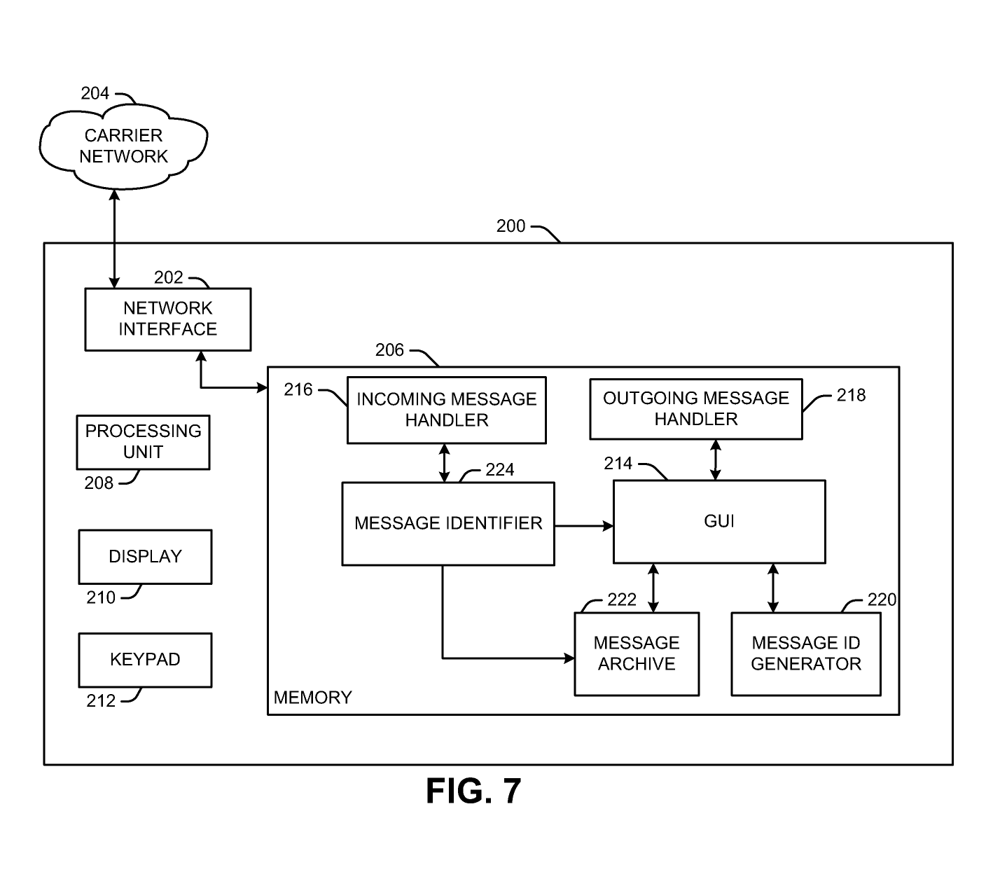

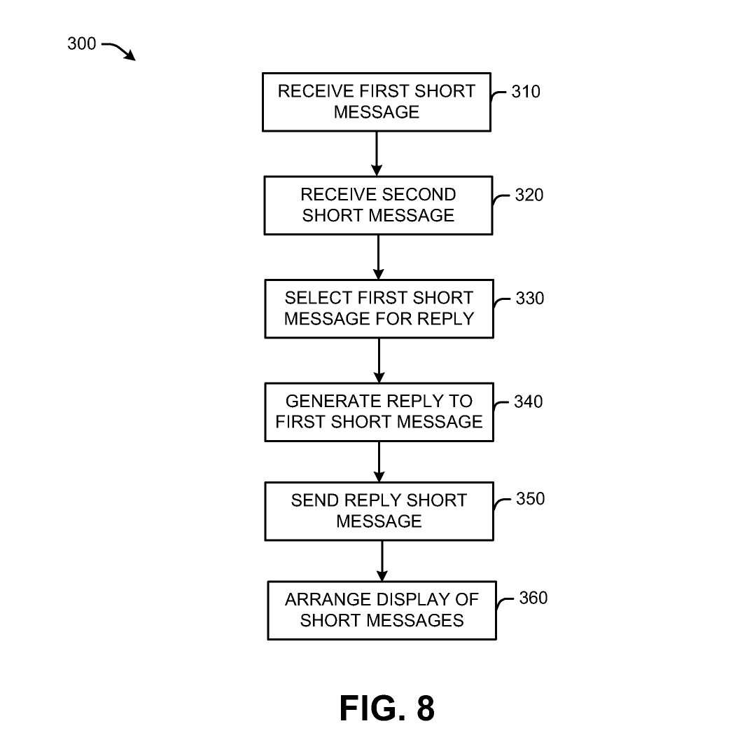

FIG. 7 illustrates an example of an end-user device 200 that could be employed as the given device 52 or the other device 54 of FIG. 1. The end-user device 200 could be employed, for example, as a smartphone, a feature phone, a tablet computer, etc. The end-user device 200 can include a network interface 202, such as a wireless network interface that communicates with a carrier network 204. The carrier network 204 could be, for example, a network on a telecommunications carrier and/or a public network, such as the Internet (e.g., for IP messaging). In some examples, the carrier network 204 could be a Fourth Generation (4G) network, a 4G Long Term Evolution (4G LTE) network, a Third Generation (3G) network, a 3G Partnership Project (3GPP) network, etc.

The end-user device 200 can include a memory 206 configured to store machine readable instructions and data. The end-user device 200 can also include a processing unit 208 configured to access the memory 206 and to execute the machine readable instructions. The processing unit 208 can include, for example, one or more processor cores. The end-user device 200 can include a display 210 that can provide output. In some examples, the display 210 can be implemented as a touch screen that can receive user input. Additionally or alternatively, the end-user device 200 can include a keypad 212 that can include buttons to receive user input.

The memory 206 can include a GUI 214 that can be configured to output short messages (e.g., text messages and/or multimedia messages) on the display 210. In some examples, the short messages can be received from the carrier network 204 via the network interface 202 at an incoming message handler 216. Additionally, a user of the end-user device 200 can employ the GUI 214 (e.g., via the keypad 212 and/or the display 210, if the display 210 is a touch screen) to generate a short message for another end-user device 200 that can be output by an outgoing message handler 218 to the carrier network 204 via the network interface 202. The short messages could be implemented, for example, as SMS messages, MMS messages, IP messages, etc. The short messages can contain text and/or multimedia content (e.g., photographs, videos, audio recordings, etc.).

The memory 206 can also include a message ID generator 220. The message ID generator 220 can be configured to sequentially or randomly generate a unique ID for each short message upon request. In some examples, the user of the end-user device 200 can employ the GUI 214 to generate content (e.g., text and/or multimedia content) for a short message that is addressed to (e.g., destined for) another end-user device 200. The other end-user device 200 could be identified, for example, by a telephone number associated with the other device or another identifier (e.g., a proper name or nickname of a user of the other device). In response to generating the content for the short message, the GUI 214 can query the message ID generator 220 for a unique ID for the short message. Content of the short message can be output at the display 210. Additionally, the GUI 214 can store the short message in a message archive 222. Each short message in the message archive 222 can include, for example, an address of a destination device, content of the short message, a unique identifier for the short message and a time stamp. The GUI 214 an also provide the short message to the outgoing message handler 218, wherein the outgoing message handler 218 can output the short message to the carrier network 204 via the network interface 202.

The incoming message handler 216 can be configured to receive an incoming short message from the carrier network 204. The incoming short message can be provided to a message identifier 224. The message identifier 224 can store the incoming message in the message archive 222. Additionally, the message identifier 224 can search the incoming message for a message ID in a reply-to field of a user data header (or other field) of the incoming message. In situations where there is a message ID present in the reply-to field, the message identifier 224 can attempt to identify another short message (e.g., a short message generated at the end-user device 200) that the incoming message is replying to. In such a situation, the message identifier 224 can extract the reply-to message ID and extract a corresponding short message (the short message being replied to) from the message archive 222. The message identifier 224 can forward the incoming short message and the corresponding short message (or a pointer to the corresponding short message) to the GUI 214. The GUI 214 can be configured to arrange an output of the short messages such that the corresponding short message is visually associated with the incoming short message (a reply short message). For instance, as illustrated in FIG. 6, the first short message 102 could be implemented as the corresponding short message and the reply to the first short message 164 can be implemented as the incoming message. Referring back to FIG. 7, in some situations, the display 210 may be “scrolled back” to a position where the corresponding short message was previously displayed.

In situations where the incoming message has no message ID in a reply-to field or the message ID in the reply-to field cannot be matched to a corresponding short message, the GUI 214 can output the content of the incoming short message in the order that the incoming short message is received.

Additionally, the user of the end-user device 200 can receive multiple incoming short messages at the incoming message handler 216. Each of the multiple incoming messages can be received at different times. In such a situation, the incoming message handler 216 can provide the multiple incoming short messages to the message identifier 224. The message identifier 224 can search each of the incoming short messages for a message ID in a reply-to field. In some situations, no message ID in the reply-to field (or no reply-to field) is included. In this situation, the message identifier 224 can provide the GUI 214 with the incoming short message, and content of the incoming short messages can be output in a chronological order indicated in a timestamp of each incoming short message. FIG. 2 illustrates an example wherein content first of the incoming short messages can be output as the first short message 102 and content of the second of the incoming short messages can be output as the second short message 104.

Referring back to FIG. 7, the user of the end-user device 200 can employ the GUI 214 to select one of the incoming short messages to generate a reply short message. For instance, the user of the end-user device 200 can select a given one of the incoming short messages and choose a reply operation. The user can also employ the GUI 214 to generate content for the reply short message. FIG. 3 illustrates this example where the first short message 102 (which can correspond to the givens short message) is selected for a reply and the user employs the GUI 214 to generate the content for the reply short message 108. Referring back to FIG. 7, in such a situation, the GUI 214 can query the message ID generator 220 for a message ID for the reply short message. The GUI 214 can access the message archive 222 to retrieve a message ID for the given short message. The GUI 214 can add the message ID for the given short message to a user data header of the reply short message. Additionally, the reply short message can include the message ID provided by the message ID generator 220, an address for the destination of the reply short message and a timestamp. The reply short message can be provided to the outgoing message handler 218, and the outgoing message handler 218 can provide the reply short message to the carrier network 204 via the network interface 202.

It is noted that in some examples, the GUI 214 can be configured such that the user of the end-user device 200 can begin generating content for a short message after a given short message has been received, but prior to completing the generation of the short message, a new incoming short message is received from the same sender that sent the given short message. In this situation, the GUI 214 can be configured to automatically set the short message being generated as a reply short message for the given short message, and the resulting reply short message can be processed and sent in a manner described herein.

By employing the end-user device 200, the user of the end-user device 200 can reply to specific short messages. Such a specific reply can reduce or eliminate ambiguity that might otherwise result in conversations where messages are only displayed in a chronological order.

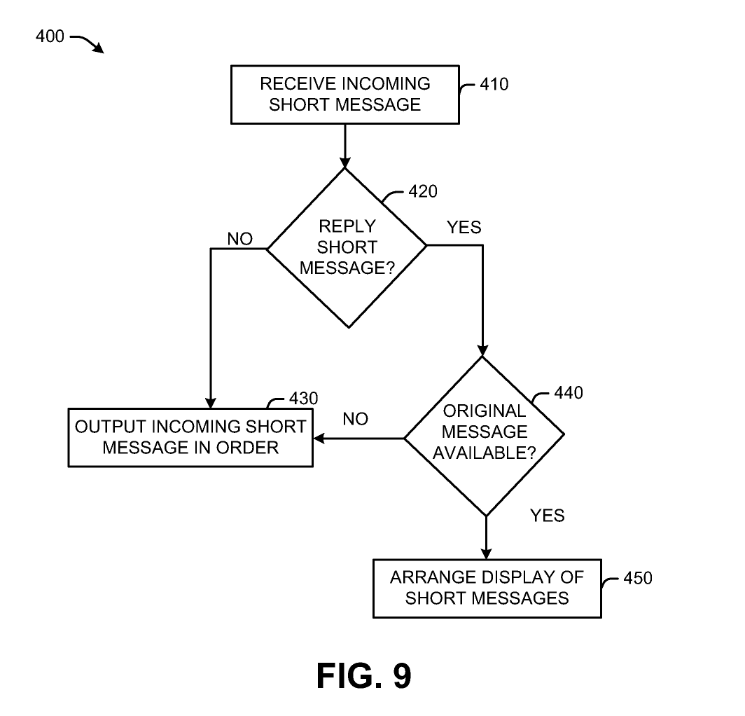

In view of the foregoing structural and functional features described above, example methods will be better appreciated with reference to FIGS. 8 and 9. While, for purposes of simplicity of explanation, the example methods of FIGS. 8 and 9 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIGS. 8 and 9 can be implemented as instructions stored in a non-transitory machine-readable medium. The instructions can be accessed by a processing resource (e.g., one or more processor cores) and executed to perform the methods disclosed herein.

FIG. 8 illustrates a flowchart of an example method 300 for generating a reply to a specific short message. The method 300 could be implemented, for example, by an end-user device, such as the given device 52 of FIG. 1, the other device 54 of FIG. 1 and/or the end-user device 200 of FIG. 7. At 310, a first short message (e.g., a text message and/or a multimedia message) can be received at the end-user device from a sender (e.g., another end-user device). At 320, a second short message can be received at the end-user device from the sender. At 330, the first short message can be selected at the end-user device (e.g., in response to user input) for a reply short message. At 340, the reply short message can be generated. The reply short message can include, for example, content (e.g., text and/or multimedia), a unique ID for the reply short message, as well as a unique ID of the first short message. Additionally, the reply short message can include an address of the sender of the first (and second) short messages.

At 350, the reply short message (destined for the sender) can be sent to a carrier network (e.g., the carrier network 56 of FIG. 1 and/or the carrier network 204 of FIG. 7). At 360, a display of short messages can be arranged such that the reply short message is visually associated with the first short message. Such visual association can include outputting the short messages in an order such that the reply short message is output directly beneath the first short message and above the second short message.

FIG. 9 illustrates a flowchart of an example method 400 for receiving a reply to a specific short message. The method 400 could be implemented, for example, by an end-user device, such as the given device 52 of FIG. 2, the other device 54 of FIG. 1 and/or the end-user device 200 of FIG. 7. At 410, an incoming short message can be received at the end-user device. At 420, the end-user device can make a determination as to whether the incoming short message is a reply short message. The determination at 420 can be based, for example on the presence or absence of a message ID in a reply-to field in a user data header (or other predetermined field) of the incoming short message. If the determination at 420 is negative (e.g., NO), the method 400 can proceed to 430. If the determination at 420 is positive (e.g., YES) the method can proceed to 440. At 430, the incoming short message can be output at a display of the end-user device in an order in which the incoming short message is received.

At 440, the end-user device can determine if the original message (the message identified in the message ID of the reply-to field of the incoming message) is available (e.g., in a message archive, such as the message archive 222 of FIG. 2). If the determination at 440 is negative (e.g., NO), the method 400 can proceed to 430. If the determination at 440 is positive (e.g., YES), the method 400 can proceed to 450. At 450, a display of the short messages at the end-user device can be arranged by the end-user device such that the reply short message is visually associated with the original message being replied to. Such visual association can be, for example, positioning the reply short message immediately beneath the original short message and above another short message.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

1. An end-user device comprising:
a display configured to output short messages;
a memory configured to store machine readable instructions and data; and
a processing unit configured to access the memory and execute the machine readable instructions, the machine readable instructions comprising:
a graphical user interface (GUI) configured to control the display to visually associate a reply short message with a given short message identified in the reply short message, wherein visually associating comprises positioning the reply short message below the given short message and above another short message on the display, wherein the other short message is displayed on the display prior to the reply short message being displayed on the display.

2. The end-user device of claim 1, wherein at least one of the reply short message and the given short message is a Short Message Service (SMS) message.

3. The end-user device of claim 1, wherein at least one of the reply short message and the given short message is a Multimedia Messaging Service (MMS) message.

4. The end-user device of claim 1, wherein at least one of the reply short message and the given short message is an Internet Protocol (IP) message.

5. The end-user device of claim 1, wherein the reply short message and the given short message each have unique identifiers.

6. The end-user device of claim 1, wherein the machine readable instructions further comprises a message identifier component configured to extract a message identifier in a field from the reply short message.

7. The end-user device of claim 6, wherein the message identifier component is further configured to identify the given short message stored in a message archive of the memory based on the message identifier extracted from the reply short message.

8. The end-user device of claim 1, wherein the reply short message and the given short message are transmitted over a telecommunications carrier network.

9. The end-user device of claim 1, wherein the GUI is further configured to control the display to output another short message that is generated prior to receiving the reply short message, wherein the other short message appears below the reply short message.

10. The end-user device of claim 1, wherein the visual association positions the reply short message beneath the given short message, wherein there are no intervening messages positioned between the reply short message and the given short message.

11. A non-transitory machine readable medium having machine executable instructions, the machine executable instructions comprising a graphical user interface (GUI) configured to:
output a given short message sent from a sender, wherein the given short message includes a message identifier;
output another short message sent from the sender;
generate a reply short message to the given short message, wherein the reply short message includes the message identifier for the given short message; and
arrange the display such that the reply short message is visually positioned between the given short message and the other short message, wherein the other short message is displayed on the display prior to the reply short message being displayed on the display.

12. The non-transitory machine readable instructions of claim 11, further comprising a message identifier generator configured to generate a unique identifier for the reply short message.

13. The non-transitory machine readable instructions of claim 11, wherein unique identifier of the given short message is stored in a user data header of the reply short message.

14. The non-transitory machine readable instructions of claim 11, wherein the reply short message is addressed to the sender.

15. The non-transitory machine readable instructions of claim 11, wherein the reply short message is a short message service (SMS) message.

16. The non-transitory machine readable instructions of claim 11, wherein the reply short message is a multimedia messaging service (MMS) message.

17. The non-transitory machine readable instructions of claim 11, wherein the GUI is further configured to select the given short message for generation of the reply short message in response to user input.

18. The non-transitory machine readable instructions of claim 11, wherein the GUI is further configured to associate the reply short message with the given short message in response to receipt of the other short message during generation of content for the reply short message.

19. The non-transitory machine readable instructions of claim 11, wherein the GUI is further configured to output tags associated with the given short message and the other short message to facilitate selection of the given short message or the other short message in response to user input at a keypad.

20. An end-user device comprising:
a display configured to output short messages;
a memory configured to store machine readable instructions and data; and
a processing unit configured to access the memory and execute the machine readable instructions, the machine readable instructions comprising:
a graphical user interface configured to:
output a first short message sent from a sender, wherein the first short message includes a message identifier;
output a second short message sent from the sender;
generate a reply short message to the first short message, wherein the reply short message includes the message identifier for the first short message;
arrange the display such that the reply short message is visually positioned beneath the first short message and above the second short message and a third short message; and
output the third short message from the sender, wherein the third short message is a reply to the reply short message, wherein the third short message is positioned below the reply short message and above the second short message, wherein the second short message is displayed on the display prior to the third short message being displayed on the display.

21. A method comprising:
receiving an incoming short message;
determining that the incoming short message is a reply short message to a given short message; and
arranging an output of short messages on a display such that the reply short message is displayed below the given short message and above another short message, wherein the other short message is displayed on the display prior to the reply short message being displayed on the display.

22. The method of claim 21, wherein the determining is based on a message identifier of the given short message in a field of the incoming short message.

23. A method comprising:
receiving a given short message and another short message from a sender;
generating a reply short message to the given short message, after the receiving;
sending the reply short message to the sender via a telecommunications carrier network; and
arranging a display of short messages on a display such that the reply short message is displayed below the given short message and above another short message, wherein the other short message is displayed on the display prior to the reply short message being displayed on the display.

24. The method of claim 23, further comprising selecting the given short message for a reply.

25. The method of claim 23, wherein the visual association positions the reply short message below the given short message and above the other short message.
